(19) United States
(12) Patent Application Publication
(10) Pub. No.: US 2009/0154852 A1
(43) Pub. Date: Jun. 18, 2009

(54) HYDRODYNAMIC BEARING DEVICE, SPINDLE MOTOR, AND INFORMATION RECORDING AND REPRODUCING APPARATUS

(76) Inventors: Takafumi ASADA, Osaka (JP); Hiroaki Saito, Ehime (JP); Daisuke Ito, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/333,903

(22) Filed: Dec. 12, 2008

(30) Foreign Application Priority Data
Dec. 17, 2007 (JP) 2007-324353

(51) Int. Cl. F16C 32/06

(52) U.S. Cl. 384/121

(57) ABSTRACT

The hydrodynamic bearing device comprises a sleeve 1, a shaft 2, a thrust bearing portion, and a lubricating fluid 5. The sleeve 1 has a bearing hole 1C. The shaft 2 is inserted into the bearing hole 1C in a state of being able to rotate relative to the sleeve 1. The thrust bearing portion has a hydrodynamic groove for generating pressure in the axial direction. The lubricating fluid 5 is held in a gap formed by the thrust bearing portion. The hydrodynamic bearing device is further constituted so that the value of a wear amount function F6 falls into a specific range. With the hydrodynamic bearing device, the required bearing performance can be satisfied, and the thrust bearing portion has a longer intermittent service life.

This application claims priority under 35 U.S.C. § 119 to Japanese Patent Application No. 2007-324353 filed on Dec. 17, 2007. The entire disclosure of Japanese Patent Application No. 2007-324353 is hereby incorporated herein by reference.

### BACKGROUND OF THE INVENTION

1. Field of the Invention

The present invention relates to a hydrodynamic bearing device or a spindle motor that is installed in a hard disk drive (hereinafter referred to as HDD) or other such information recording and reproducing apparatus, and to such an information recording and reproducing apparatus.

2. Description of the Related Art

Information recording and reproducing apparatus and the like that make use of a rotating disk for recording and reproducing information have grown in memory capacity, and their data transfer rate has also risen. Accordingly, the disk rotation device used in such apparatus needs to offer high performance and reliability so that the disk can always be rotated at high accuracy. In view of this, a device that features a hydrodynamic bearing which is suited to high-speed rotation (hereinafter referred to as a hydrodynamic bearing device) is generally used for such disk rotation devices.

A “hydrodynamic bearing device” is a device that rotates a shaft in a state of non-contact with a sleeve, by interposing oil (a lubricating fluid) between the shaft and sleeve and generating pumping pressure during rotation by means of a hydrodynamic groove. This hydrodynamic bearing device affords stable, high-speed rotation because there is no mechanical friction between the shaft and sleeve during steady-state rotation.

A conventional hydrodynamic bearing device, as shown in FIG. 18, comprises a sleeve 101, a shaft 102, and a flange 103 provided integrally to the shaft 102.

The flange 103 is provided with hydrodynamic grooves 103A and 103B. A thrust plate 104 is provided opposite the flange 103, and forms a thrust bearing.

A lubricating fluid 105 is held in a gap formed by the sleeve 101, the shaft 102, the flange 103, and the thrust plate 104.

When the shaft 102 rotates, the hydrodynamic grooves 103A and 103B rake up the lubricating fluid 105 held in the bearing gap, which generates pumping pressure between the flange 103 and the thrust plate 104. As a result, the shaft 102 can rotate in a state of non-contact with respect to the sleeve 101 and the thrust plate 104.

A hydrodynamic bearing device such as that described above is disclosed in, for example, FIGS. 1 and 2 of Japanese Laid-Open Patent Application S61-010939, which discloses the float commencement rotating speed that is estimated to affect progress of the wear of the thrust bearing.

A hydrodynamic bearing device such as that described above, and a HDD equipped with this hydrodynamic bearing device, usually employ an intermittent rotation method, in which the disk is rotated only during recording and reproduction, rather than a constant rotation method, in which the disk is constantly rotated as in the past, in order to cut down on the power consumed during use. Accordingly, the service life in number of starts in an intermittent rotation method involving repeated starting and stopping of the device (hereinafter referred to as the intermittent service life) needs to be increased from the conventional 200,000 times up to approximately 1,000,000 times. To this end, the hydrodynamic bearing device must be equipped with a thrust bearing portion with superior wear resistance. The “thrust bearing portion” referred to here is the portion formed by the shaft 102, the flange 103, and the thrust plate 104.

With the above-mentioned conventional configuration, however, if the hydrodynamic bearing device is started and stopped many times under high temperature conditions (such as 70° C. or higher), at which the viscosity of the lubricating fluid 105 is lower, the weight of the rotor and other such factors will be applied to the thrust bearing portion in the direction of the arrow in FIG. 18. As a result, the planar pressure between the opposing surfaces of the flange 103 and the thrust plate 104 can rise extremely high in places, producing abrasion. This leads to the danger of bearing seizure in the area marked A in FIG. 18.

The PV value has long been a parameter based on experimental theory for non-float type (contact type) sliding bearings. It is known that this parameter expresses a relationship in which the greater is the value of the product of bearing load and rotational speed, the more abrasion there is, and the shorter is the service life.

However, there is no suitable parameter related to the service life of a thrust bearing by continuous rotation of a hydrodynamic bearing device. The above-mentioned PV value theory is not applicable at all to an intermittent service life in a floating rotation type of hydrodynamic bearing device in which the bearing is in contact and begins to float at start-up, and makes the transition to non-contact rotation once a specific rotational speed is reached. Therefore, to predict the intermittent service life of a floating rotation type of hydrodynamic bearing device, the hydrodynamic bearing device had to be actually designed, produced, and measured.

Also, with many hydrodynamic bearing devices, bearing seizure occurred at an intermittent service life much shorter than 1,000,000 times.

In light of such problems, one method that was employed in the past to prevent abrasion in a thrust bearing was to design the device so as to have more float than required in its thrust plate 104. However, since there are many other factors behind the generation of this abrasion, there was no way the problem could be solved merely by specifying the amount of float.

If safety with regard to this abrasion was given too much importance, so that the bearing surface area was increased too much in order to provide extra float, or the viscosity of the lubricating fluid was increased too much, then a problem was that the other aspects of performance required of the bearing, such as bearing loss torque, could not be satisfied.

### SUMMARY OF THE INVENTION

In view of this, it is an object of the present invention to provide a thrust bearing portion that can satisfy the required bearing performance and have a longer intermittent service life, on the basis of a novel design concept that is different from that used in the past.

To achieve the stated object, the hydrodynamic bearing device according to a first aspect of the present invention comprises a sleeve having a bearing hole, a shaft that is inserted into the bearing hole in a state of being capable of rotating relative to the sleeve, a thrust bearing portion having a hydrodynamic groove that generates pressure in an axial direction, and a lubricating fluid adapted to be held in a gap formed by at least the thrust bearing portion, the device being configured such that a value of a function F6 expressed by Formula 1 in the following <1> is within a specific range.

<1>

F6=F2×Ro (1)

F2=S²×Pz/(C²×η×(Ro⁴−Ri⁴)) (2)
S: thrust bearing face tilt amount

S=θ×2×Ro (3)
θ: thrust bearing face tilt angle
   θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

Preferably, the hydrodynamic bearing device according to the first aspect of the present invention is configured such that the value of the function F6 satisfies the following: F6<1.2.

Furthermore, it is preferable that the hydrodynamic bearing device according to the first aspect of the present invention is configured such that the value of the function F6 satisfies the following: F6>0.5.

The hydrodynamic bearing device according to a second aspect of the present invention comprises a sleeve having a bearing hole, a shaft that is inserted into the bearing hole in a state of being capable of rotating relative to the sleeve, a thrust bearing portion having a hydrodynamic groove that generates pressure in an axial direction, and a lubricating fluid adapted to be held in a gap formed by at least the thrust bearing portion, the device being configured such that a value of a function F7 expressed by Formula 4 in the following <2> is within a specific range.

<2>

F7=F2×Ro/At (4)

F2=S²×Pz/(C²×η×(Ro⁴−Ri⁴)) (5)

At=π×(Ro²−Ri²) (6)
S: thrust bearing face tilt amount

S=θ×2×Ro (7)
θ: thrust bearing face tilt angle
   θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

Preferably, the hydrodynamic bearing device according to the second aspect of the present invention is configured such that the value of the function F7 satisfies the following: F7≦7×10⁴.

Furthermore, it is preferable that the hydrodynamic bearing device according to the second aspect of the present invention is configured such that the value of the function F7 satisfies the following: F7>2.5×10⁴.

Further preferably, the hydrodynamic bearing device according to the first or second aspect of the present invention further comprises a lubricating fluid reservoir that has an opening in the axial direction and adapted to hold a lubricating fluid that is moved by the pressure from the thrust bearing portion, the device being configured such that the relationship Pt>Pg is satisfied, where Pt is the capillary pressure function at the maximum gap T of the thrust bearing portion, and Pg is the capillary pressure function at the maximum gap G of the opening in the lubricating fluid reservoir.

The function Pg is expressed by Formula 13 in the following <3> when a gap shape of the opening in the lubricating fluid reservoir is substantially that of a circular tube.

<3>

Fgo=π×Do×γ×cos θ (8)

Fgi=π×Di×γ×cos θ (9)

Di=Do−2×rg (10)

Fg=Fgo+Fgi (11)

Ag=7×(Do²−Di²)/4 (12)

Pg=Fg/Ag (13)
γ: surface tension of lubricating fluid (N/m)
θ: contact angle of lubricating fluid (rad)
Do: outside diameter of circular tube
Di: inside diameter of circular tube
rg: lubricating fluid film thickness on circular tube (m)

The function Pt is expressed by Formula 16 in the following <4> when a gap shape of the thrust bearing portion is substantially that of a thin disk.

<4>

Ft=2π×Dt×γ×cos θ (14)

At=π×Dt×T (15)

Pt=Ft/At (16)
Dt: outside diameter of thrust bearing face having the maximum gap T (m)
T: film thickness of lubricating fluid on thrust bearing portion (m)

T=t1+t2 (m) (17)
t1: a gap in the upward direction of the thrust bearing
t2: a gap in the downward direction of the thrust bearing

Further preferably, the hydrodynamic bearing device according to the first or second aspect of the present invention further comprises a lubricating fluid reservoir that has an opening in the axial direction and adapted to hold a lubricating fluid that is moved by the pressure from the thrust bearing portion, the device being configured such that the relationship Pt>Pg is satisfied, where Pt is the capillary pressure function in a maximum gap T of the thrust bearing portion, and Pg is the capillary pressure function in a maximum gap G of the opening in the lubricating fluid reservoir. The function Pg is expressed by Formula 13 in the following <3> when a gap shape of the opening in the lubricating fluid reservoir is substantially that of a circular tube.

<3>

Fgo=π×Do×γ×cos θ (8)

Fgi=π×Di×γ×cos θ (9)

Di=Do−2×rg (10)

Fg=Fgo+Fgi (11)

Ag=π×(Do²−Di²)/4 (12)

Pg=Fg/Ag (13)
γ: surface tension of lubricating fluid (N/m)
θ: contact angle of lubricating fluid (rad)
Do: outside diameter of circular tube
Di: inside diameter of circular tube
rg: lubricating fluid film thickness on circular tube (m)

The function Pt is expressed by Formula 20 in the following <5> when a gap shape of the thrust bearing portion is substantially that of a hollow disk.

<5>

Ft=2π×Dh×γ×cos θ (18)

At=π×Dt×T (19)

Pt=Ft/At (20)
Dh: inside diameter of thrust bearing face having the maximum gap T (m)
T: film thickness of lubricating fluid on thrust bearing portion (m)

T=t1+t2 (m) (21)
t1: a gap in the upward direction of the thrust bearing
t2: a gap in the downward direction of the thrust bearing

In the hydrodynamic bearing device according to the first or second aspect of the present invention, it is preferable that the shaft is composed of stainless steel, high-manganese chromium steel, or carbon steel, the sleeve is composed of stainless steel or a copper alloy, and the surface of the sleeve has been subjected to electroless nickel plating or DLC coating.

In the hydrodynamic bearing device according to the first or second aspect of the present invention, it is preferable that the shaft is composed of stainless steel, high-manganese chromium steel, or carbon steel, the sleeve is a sintered alloy containing at least 90% iron, and a triiron tetroxide film, a diiron trioxide film, or other such hard oxide film is formed on the surface of the sleeve.

In the hydrodynamic bearing device according to the first or second aspect of the present invention, it is preferable that the absolute viscosity of the lubricating fluid at 70° C. is between 2 and 5 centipoise (0.002 to 0.005 [N·S/m²]).

In the hydrodynamic bearing device according to the first or second aspect of the present invention, it is preferable that the surface roughness of the thrust bearing portion is between 0.01 and 1.6 μm.

The spindle motor according to a further aspect of the present invention comprises the hydrodynamic bearing device according to the first or second aspect of the present invention.

The information recording and reproducing apparatus according to a further aspect of the present invention comprises the hydrodynamic bearing device according to the first or second aspect of the present invention.

The present invention therefore provides a hydrodynamic bearing device equipped with a thrust bearing portion that can satisfy the required bearing performance and have a longer intermittent service life, on the basis of a novel design concept that is different from that used in the past. The present invention also provides a spindle motor equipped with such a hydrodynamic bearing device, and an information recording and reproducing apparatus with the spindle motor.

### BRIEF DESCRIPTION OF DRAWINGS

FIG. 1 is a cross section of the structure of a spindle motor comprising a hydrodynamic bearing device pertaining to Embodiment 1 of the present invention;

FIG. 2 is a plan view of the thrust hydrodynamic groove pattern of the hydrodynamic bearing device;

FIG. 3 is a plan view of the thrust hydrodynamic groove pattern of the hydrodynamic bearing device;

FIG. 4 is a graph of the intermittent service life of a thrust bearing face versus the function F2 in the hydrodynamic bearing device;

FIG. 5 is a graph of the intermittent service life of a thrust bearing face versus the function F6 in the hydrodynamic bearing device;

FIG. 6 is a graph of the intermittent service life of a thrust bearing face versus the function F7 in the hydrodynamic bearing device;

FIG. 7 is a graph of the bearing frictional torque ratio versus the functions F6 and F7 of the hydrodynamic bearing device;

FIG. 8 is a cross section of the structure of the hydrodynamic bearing device pertaining to Embodiment 1;

FIG. 9 is a diagram illustrating the principle behind the capillary pressure function of the hydrodynamic bearing device;

FIG. 10 is a graph of the capillary pressure differential of the hydrodynamic bearing device;

FIG. 11 is a diagram of a capillary pressure function calculation model for the hydrodynamic bearing device;

FIG. 12 is a diagram of a capillary pressure function calculation model for the hydrodynamic bearing device;

FIG. 13 is a partial cross section of the structure of the spindle motor pertaining to Embodiment 2 of the present invention;

FIG. 14 is a partial cross section of the structure of the spindle motor pertaining to Embodiment 3 of the present invention;

FIG. 15 is a cross section of an information recording and reproducing apparatus equipped with the hydrodynamic bearing device of the present invention;

FIG. 16 is a graph of the rotational precision degradation versus the function F6 of the hydrodynamic bearing device;

FIG. 17 is a graph of the relationship between the thrust float height reduction rate and the function F6 of the hydrodynamic bearing device; and

FIG. 18 is a cross section of main constituent part of a conventional hydrodynamic bearing device.

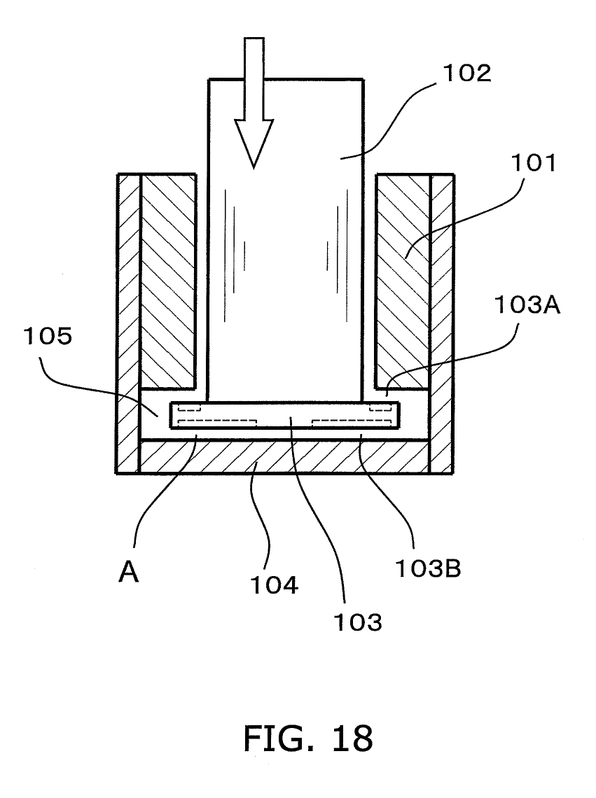

### REFERENCE NUMERALS IN DRAWINGS

1, 21, 31 sleeve
1A, 1B, 21B, 31B radial hydrodynamic groove
1C, 21C, 31C bearing hole
1E lubricating fluid reservoir
2, 22, 32 shaft
3, 23, 33 flange
3A, 3B, 23A, 23B, 31E, 38A thrust hydrodynamic groove
4, 24, 34 thrust plate
5, 25, 35 lubricating fluid
6, 26, 36 base
7, 27, 37 hub rotor
8 stator
9 rotor magnet
10 disk
11 clamper
12 spacer
13 screw
15, 30, 40 spindle motor
19, 39, 49 hydrodynamic bearing device
100 information recording and reproducing apparatus

### DETAILED DESCRIPTION OF THE INVENTION

Embodiments of the hydrodynamic bearing device, a spindle motor, and an information recording and reproducing apparatus equipped with this spindle motor according to the present invention will now be described in detail through reference to the drawings.

### Embodiment 1

Configuration of Spindle Motor 15

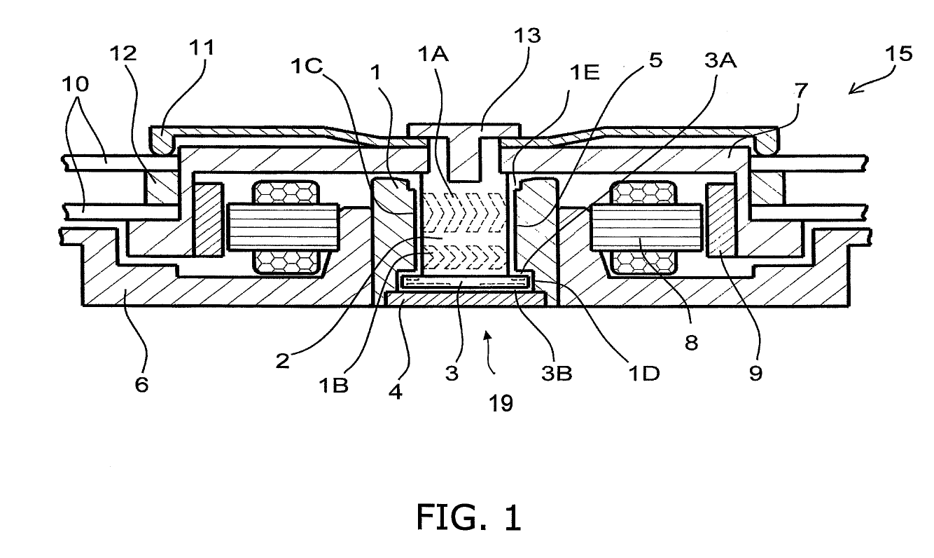

FIG. 1 is a cross section of a spindle motor 15 in Embodiment 1 of the present invention.

As shown in FIG. 1, the spindle motor 15 of this embodiment comprises a hydrodynamic bearing device 19, a base 6, a topped cylindrical hub rotor 7, a stator 8 wound with a coil and having on its outer peripheral side a plurality of protruding poles, and a hollow cylindrical rotor magnet 9.

The hydrodynamic bearing device 19 has a substantially hollow cylindrical sleeve 1, a substantially solid cylindrical shaft 2, a substantially disk-shaped flange 3 that is integrated with the shaft 2, a substantially disk-shaped thrust plate 4, and lubricating fluid 5 such as oil.

The shaft 2 is inserted in a rotatable state in a bearing hole 1C in the sleeve 1. The flange 3 is attached to the lower end of the shaft 2, and is accommodated in a recess 1D provided at one end of the sleeve 1. The flange 3 here may be machined integrally with the shaft 2.

The lubricating fluid 5 may be, for example, an ester-based oil, a fluorine oil, a silicone oil, an olefin oil, or an ionic liquid. The lubricating fluid 5 need not be oil, and may be a high-fluidity grease, an ionic liquid, or the like.

Radial hydrodynamic grooves 1A and 1B in a herringbone or other such pattern are provided to the outer peripheral surface in the circumferential direction of the shaft 2 and/or to the inner peripheral surface of the bearing hole 1C, forming a radial bearing surface. Meanwhile, thrust hydrodynamic grooves 3A and 3B are provided to the face of the flange 3 that is opposite the thrust plate 4 in the axial direction and to the face of the flange 3 that is opposite the sleeve 1 in the axial direction, forming thrust bearing faces (thrust bearing portion).

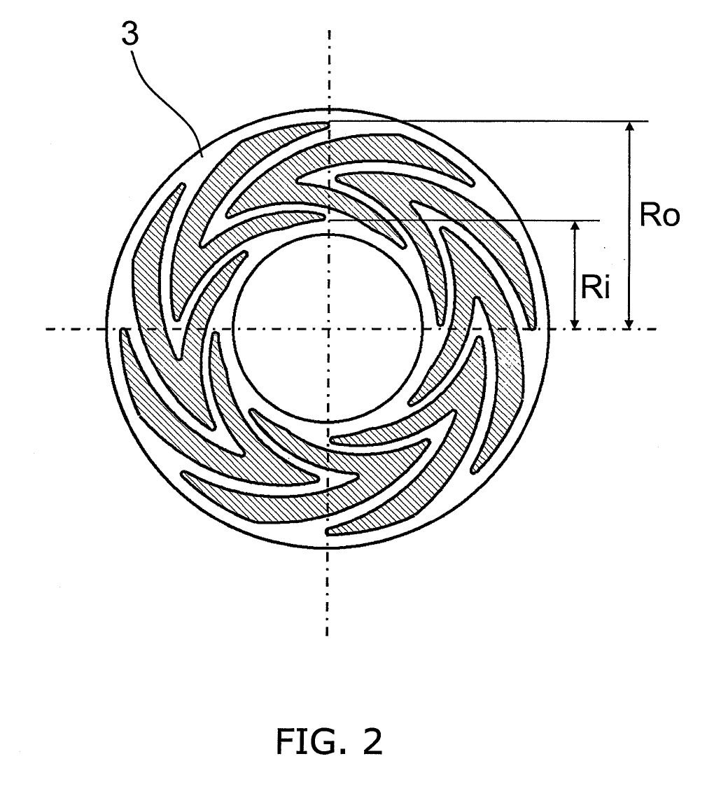

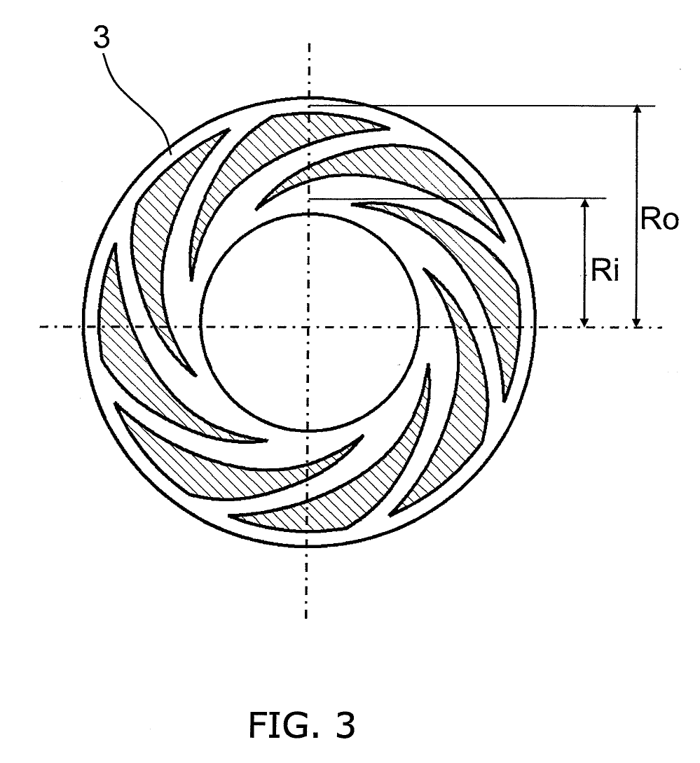

The thrust hydrodynamic groove 3A here that may be formed in an opposing face in the axial direction at either one of the flange 3 and the sleeve 1 is usually in the herringbone pattern shown in FIG. 2, but may instead be a groove with the spiral pattern shown in FIG. 3. Also, the thrust hydrodynamic groove 3B here that may be formed in an opposing face in the axial direction at either one of the flange 3 and the thrust plate 4 is usually in the spiral pattern shown in FIG. 3, but may instead be a groove with the herringbone pattern shown in FIG. 2.

The thrust plate 4 is fixed to the sleeve 1 by crimping, adhesive bonding, crimping and adhesive bonding, welding, or the like.

As shown in FIG. 1, a stepped lubricating fluid (oil) reservoir 1E provided by machining a circular groove around the sleeve 1 or the shaft 2 is formed at the opening of the sleeve 1. This lubricating fluid reservoir 1E may have a tapered shape that increases in diameter from the bearing hole of the sleeve 1 toward the opening.

At least the bearing gaps near the hydrodynamic grooves 1A, 1B, 3A, and 3B shown in FIG. 1 are filled with the lubricating fluid 5.

The sleeve 1 of the hydrodynamic bearing device 19 is fixed to the base 6 by press fitting, adhesive bonding, crimping, welding, or the like. The upper portion of the shaft 2 of the hydrodynamic bearing device 19 is fixed to the hub rotor 7 by press fitting, adhesive bonding, or press fitting and adhesive bonding, and may be further welded, etc. The rotor magnet 9, a disk 10, and a spacer 12 are fixed to the hub rotor 7. A clamper 11 is fixed to the hub rotor 7 by a screw 13. A coil for generating a rotary magnetic field is wound around the stator 8, and the stator 8 is fixed to the base 6 in a state of having a specific gap with the rotor magnet 9.

The rotor magnet 9, the hub rotor 7, the shaft 2, the flange 3, the disk 10, the spacer 12, the clamper 11, and the screw 13 constitute a rotational portion. The rotational portion is usually configured such that it is attracted toward the base 6 by the magnetic force of the rotor magnet 9, etc., when stopped and no pumping pressure is generated. For example, if the base 6 is a magnetic material, a leakage magnetic path is formed between the base 6 and the end face of the rotor magnet 9, which generates an attractive force. If the base 6 is a non-magnetic material, on the other hand, an attractive force is generated by disposing an attraction plate of a magnetic material (not shown) at a location on the base 6 opposite the end face of the rotor magnet 9.

Operation of the Spindle Motor 15

The operation of the spindle motor 15 that has the above constitution will now be described.

With the spindle motor 15 in this embodiment shown in FIG. 1, when power is sent to the coil wound around the stator 8, a rotary magnetic field is generated, and rotational force is imparted to the rotor magnet 9. This rotational force causes the rotational portion, which includes the rotor magnet 9, the hub rotor 7, the shaft 2, the flange 3, the disk 10, the spacer 12, the clamper 11, and the screw 13, to begin rotating.

This rotation also causes the hydrodynamic grooves 1A, 1B, 3A, and 3B to rake up the lubricating fluid 5, generating pumping pressure between the shaft 2 and the sleeve 1, between the flange 3 and the sleeve 1, and between the flange 3 and the thrust plate 4.

This pumping pressure causes the rotational portion to float, and the shaft 2 to rotate in a state of non-contact with the sleeve 1 and the thrust plate 4.

With a recording and reproducing apparatus equipped with the spindle motor 15 that rotates in this manner, the recording and reproduction of data, information, etc., to the disk 10 can be performed by a magnetic head or an optical head (not shown).

Novel Technological Concept Pertaining to the Hydrodynamic Bearing Device 19, and Definition of Functions

The novel technological concept pertaining to the hydrodynamic bearing device 19 pertaining to this embodiment, and the definition of functions, will now be described.

The hydrodynamic bearing device 19 in this embodiment introduces the functions F6 and F7 given below, and these functions are within a different range from that in prior art.

First, Function F6 is expressed by Formula 1 in the following <1>.

<1>

F6=F2×Ro (1)

F2=S²×Pz/(C²×η×(Ro⁴−Ri⁴)) (2)

S: thrust bearing face tilt amount

S=θ×2×Ro (3)
θ: thrust bearing face tilt angle
   θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

Function F7 is expressed by Formula 4 in the following <2>.

<2>

F7=F2×Ro/At (4)

F2=S²×Pz/(C²×η×(Ro⁴−Ri⁴)) (5)

At=π×(Ro²−Ri²) (6)
S: thrust bearing face tilt amount

S=θ×2×Ro (7)
θ: thrust bearing face tilt angle
   θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

How the above formulas were derived will now be described.

The problem to be solved by the hydrodynamic bearing device 19 pertaining to this embodiment is to increase the service life of the thrust bearing face formed by the shaft 2, the flange 3, and the thrust plate 4, while also satisfying the required bearing performance and ensuring a suitable intermittent service life number. This was a technical problem of high difficulty in the past.

In solving this problem, we will first identify the causes of wear, and then surmise the wear mechanism, and give theories for conditions under which wear is less likely to occur. These theories will be corroborated with experimental data. By corroborating these theories we will clarify the mechanism of wear, and at the same time we will derive new logical formulas or functions capable of expressing the intermittent service life of the thrust bearing face. Finally, we will identify a method for solving the problem or favorable constitution conditions by means of these new logical formulas or functions. The novel technological concept and functions of the hydrodynamic bearing device 19 pertaining to this embodiment will now be described.

Causes of Wear to a Thrust Bearing Face

The causes of wear to a thrust bearing portion are arranged and clarified as follows.

a) Causes of Wear

Amount of flange float, rotational speed at the start of float, load in the thrust direction, material, insufficient machining precision, abrasive particle discharge, bearing surface area, lubricating fluid fill ratio

The lubricating fluid fill ratio is a proportional surface area (%) over which the thrust hydrodynamic bearing face is filled with the lubricating fluid. It is preferably such that no oil film separation is caused by admixture of bubbles, etc.

b) Factors Related to Lubricating Fluid Fill Ratio

Lubricating fluid performance, viscosity, lubricating fluid leakage, capillary pressure differential (bubbles are discharged more easily if there is a pressure differential)

c) Other Causes: Temperature, etc.

The service life and rotational speed at the start of float of the thrust bearing face are believed to be determined by combinations of these factors.

Here, the service life of the thrust bearing face that is the required performance of a hydrodynamic bearing device is defined as follows. An intermittent start-up experiment was conducted at 70° C. (rotation for 20 seconds, stopped for 70 seconds, for a total of 90 seconds each cycle), and the number of start-ups until the thrust bearing face wear down so much that start-up is impossible is termed the intermittent service life.

Surmising the Wear Mechanism

From the above factors we can surmise the following six points regarding the wear mechanism of the thrust bearing face.

a) Rotation becomes impossible and the end of the service life is reached when wear generates dust on the thrust bearing face and this dust builds up and coheres in the bearing gap.

b) Thrust bearing wear occurs during contact at the start-up and stopping of a floating hydrodynamic bearing.

c) It is surmised that if the rotational speed at the start of float is sufficiently reduced in a thrust bearing, even if the bearing face does rub, the amount of wear particles generated can still be reduced a certain amount.

d) The rotational speed at the start of float of the thrust bearing face is determined by machining error of the bearing components, which includes the surface roughness, flatness, warping, and so forth between opposing bearing faces. Contact is eliminated, and the floating of the thrust bearing face begins, at the point when the rotational speed rises high enough to generate float force beyond the amount of these factors that impede complete floating (hereinafter referred to as “float impeding factor height”). The float impeding factor height here is actually 1 μm or more.

e) The primary factor behind the float impeding factor height is twisting or tilting of the thrust bearing face. The diameter of the thrust bearing face is related to the rotational speed at the start of float and is proportional to the amount of tilt. With the hydrodynamic bearing device in the present invention, this amount of tilt is (0.0002 mm/thrust bearing diameter in millimeters), and this is a standard value for mass produced parts in this industry. θ in the formula is assumed to be a very small amount in producing the formula.

f) The quantity of wear particles generated at the thrust bearing face affects the service life. In addition, it can be hypothesized that the effect on service life is lessened depending on the bearing surface area.

Theories of Conditions Under Which Wear is Less Likely

When the wear mechanism is set forth as above, we obtain the following seven theories regarding conditions under which wear is less likely to occur. The functions necessary for the various theories are defined as follows.

Theory 1: A function expressing the thrust bearing float height at 70° C. is kept at a constant level or higher.

Theory 2: A function F2 expressing the rotational speed at the start of thrust float at 70° C. is kept at a constant level or lower.

Theory 3: A function expressing (function F2×thrust rotor weight) is kept at a constant level or lower.

Theory 4: A function expressing (function F2×total thrust load) is kept at a constant level or lower.

Theory 5: A function F5 (≡function F2/bearing surface area) is kept at a constant level or lower.

Theory 6: A wear amount function F6 (≡function F2×bearing radius) is kept at a constant level or lower.

With this theory 6, it is hypothesized that the diameter of the thrust bearing face is proportional to the amount of tilt and related to the rotational speed at the start of float.

Theory 7: A wear effect function F7 (≡function F2×bearing radius/bearing surface area) is kept at a constant level or lower.

With this theory 7, it is hypothesized that the wear particles generated by logic based on the first theory have less effect on service life depending on the bearing surface area.

Derivation of Logical Formulas

The above-mentioned theories (based on surmising the mechanism by which the thrust bearing face wears) were corroborated by experimental data, and a logical formula was derived.

Prior to deriving a logical formula, the correlation between the above-mentioned theories 1 to 7 and the actual intermittent service life was examined. As a result, a weak correlation with intermittent service life was found for theory 2. With theories 6 and 7, it was confirmed that the correlation with the service life of the thrust hydrodynamic bearing is extremely strong. On the other hand, with theories 1, 3, 4, and 5, it was confirmed that the correlation with intermittent service life is extremely weak. Function F2 in theory 2 is the rotational speed at the start of thrust float, function F6 in theory 6 is a wear amount function (±function F2×bearing radius), and function F7 in theory 7 is a wear effect function (≡function F2×bearing radius/bearing surface area).

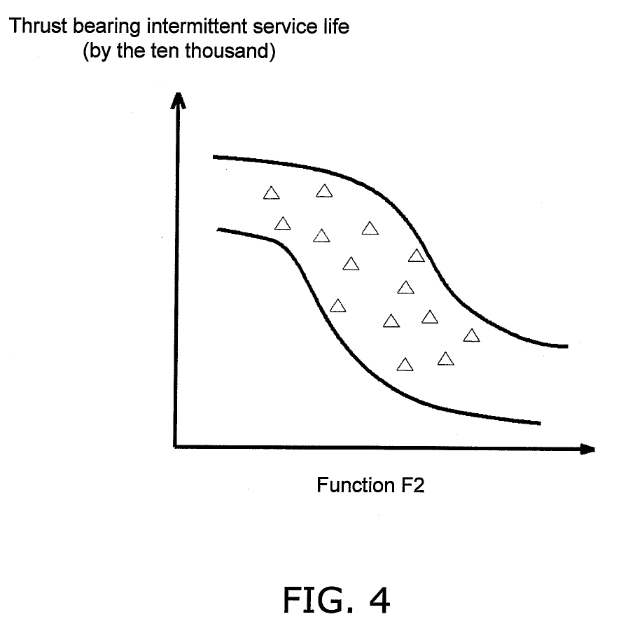

Functions F2, F6, and F7 will now be described in detail through reference to FIGS. 4, 5, and 6.

Correlation Between Function F2 and Intermittent Service Life

FIG. 4 shows the correlation found by plotting the relationship between the value of function F2 and the intermittent service life of the thrust bearing face in a hydrodynamic bearing device that is actually designed and produced. As shown in FIG. 4, a weak correlation is noted in the relationship between function F2 and the intermittent service life of the thrust bearing face. However, this correlation could not be considered adequate, and the intermittent service life of the thrust bearing face could not be increased sufficiently merely by keeping the function F2 at or below a specific level. This is because there are many other factors affecting the wear resistance of a thrust bearing face besides the float rotational speed. In other words, this means that defining a new function that takes other affecting factors into account is necessary to obtain a thrust bearing face with a longer service life.

The correction coefficient C in function F2 and so forth is a constant for matching the calculated value of function F2 to the measured value for the amount of float that exceeds the amount of tilt of the thrust bearing of the hydrodynamic bearing device 19, and is treated as a set value. The correction coefficient C is used for adjusting different measurement units (meters, millimeters, etc.) of the various parameters, and so forth. At least as regards the thrust bearing of the hydrodynamic bearing device 19 within the scope of specifications handled in the present invention, the correction coefficient C may be treated as a constant.

Correlation Between the Function F6 and the Intermittent Service Life

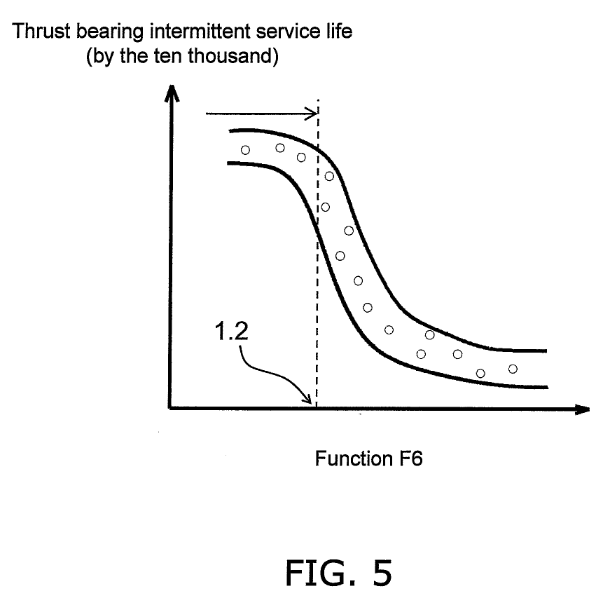

Next, FIG. 5 is a graph of the relationship between the function F6 and the intermittent service life of the thrust bearing face.

FIG. 5 shows the correlation obtained by plotting the relationship between the intermittent service life and the value of the function F6 of a hydrodynamic bearing device that is actually designed and produced. It was confirmed from this graph that a good correlation is obtained between the function F6 and the intermittent service life of the thrust bearing face. That is, it is clear that the intermittent service life changes markedly when the value of the function F6 is 1.2. Therefore, with the hydrodynamic bearing device 19, it was confirmed that to predict the intermittent service life of the thrust bearing face, defining the function F6 as a new function is effective as an index for evaluating the wear resistance of the thrust bearing face.

We will now discuss the relationship between actual physical phenomena and the critical point of the intermittent service life of the thrust bearing face indicated by function F6, that is, when F6 is 1.2. It was confirmed that this function F6, which refers to an index for evaluating wear resistance, has a correlation with the intermittent service life of a real hydrodynamic bearing device that is actually designed and produced as discussed above. As shown in FIG. 5, we can conclude that if the numerical value of function F6 is too large, the bearing face will be in an abnormal wear region, and if the numerical value of function F6 is in a favorable region of 1.2 or less, the bearing face is in its normal wear region or a no-wear region. The phrase “no-wear region” means that the surface stress applied to the bearing face is under the elasticity limit of the material from which the bearing is formed, and that the bearing is in a state of being extremely unlikely to be worn.

To put this more specifically, in FIG. 5 an inflection point is seen around where the numerical value of the function F6 is around 1.2, and in the region where the function F6 exceeds 1.2, the intermittent service life of the hydrodynamic bearing device becomes much shorter. That is, in the region where the function F6 is 1.2 or less, it can be surmised that normal wear (Break-in wear or Normal rubbing wear) is occurring at the surface of the sleeve 1 or the shaft 2 and the components are being properly lubricated. On the other hand, in the region where the function F6 is over 1.2, it can be surmised that the mode of wear has changed and abnormal wear (severe wear, etc.) is occurring.

In the region where the function F6 is 1.2 or less, there is extremely little planar pressure on the bearing surface, and this planar pressure is kept within the elasticity limit of the material from which the bearing of the sleeve 1 and the shaft 2 is formed, so the amount of wear is substantially zero. That is, in the region where the function F6 is 1.2 or less, it is believed that a state can be created in which the intermittent service life is semi-permanent.

Thus, the hydrodynamic bearing device 19 in this embodiment is constituted such that the value of the above-mentioned function F6 is F6<1.2. It can be seen that this yields a thrust bearing face with a longer intermittent service life.

Correlation Between Function F7 and Intermittent Service Life

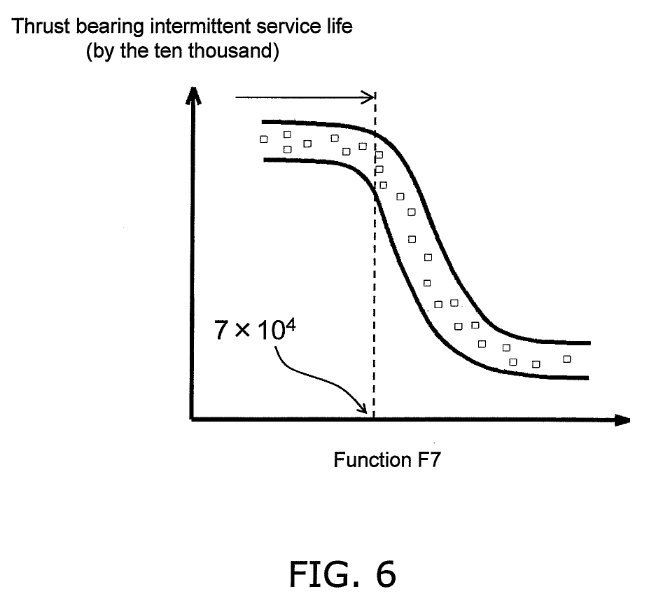

FIG. 6 is a graph of the relationship between the value of a function F7 and the intermittent service life of a thrust bearing face.

FIG. 6 was obtained by plotting the relationship of the value of the function F7 of a hydrodynamic bearing device that is actually designed and produced, to the intermittent service life of this device. It was confirmed from this graph a good correlation is obtained between function F7 and the intermittent service life of the thrust bearing face. That is, the graph clearly demonstrates that there is a marked change in the intermittent service life at a function F7 value of 7×10⁴. Therefore, it was confirmed that with the hydrodynamic bearing device 19, to predict the intermittent service life of a thrust bearing face, defining the above-mentioned function F7 is effective as a new index for evaluating the wear resistance of a thrust bearing face.

It was confirmed that this function F7, which refers to the amount of wear and its effect, is correlated to the intermittent service life of a hydrodynamic bearing device that is actually designed and produced. As shown in FIG. 6, we can assume that if the numerical value of function F7 is too large, the bearing face will be in the abnormal wear region, and if the numerical value of function F7 is in a suitable range such as 7×10⁴ or less, the bearing face is in its normal wear region or a no-wear region. The phrase “no-wear region” means that the surface stress applied to the bearing face is under the elasticity limit of the material from which the bearing is formed, and that the bearing is in a state of being extremely unlikely to be worn.

Thus, the hydrodynamic bearing device in this Embodiment 1 is constituted such that the value of the above-mentioned function F7 is F7≦7×10⁴. It can be seen that this yields a thrust bearing face with a longer intermittent service life.

Correlation Between Functions F6 and F7 and Bearing Frictional Torque Ratio

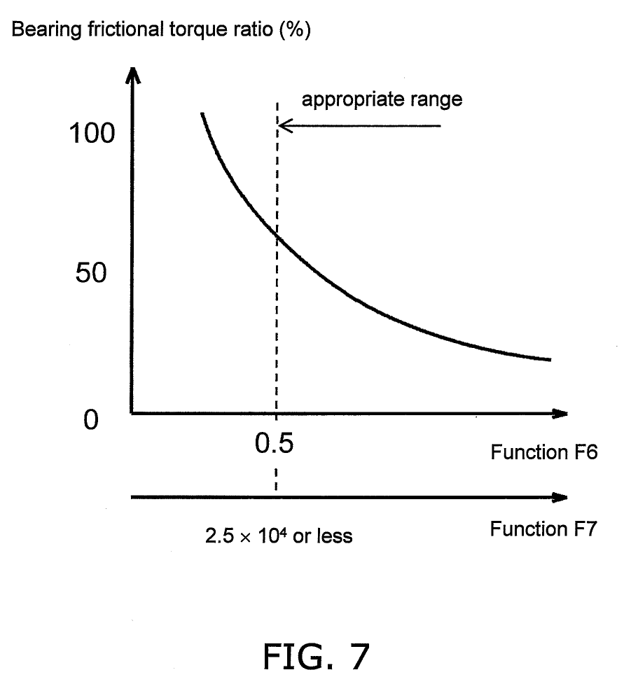

FIG. 7 is a graph of the relationship between the functions F6 and F7 and the bearing frictional torque ratio. The “bearing frictional torque ratio” is the ratio of the bearing frictional torque that is lost versus a conventional bearing.

For example, the viscosity of the lubricating fluid may be increased to reduce the function F6 (the amount of wear), but if the lubricating fluid viscosity is increased, the function F6 decreases in value as can be seen from the mathematical formulas given above. However, if the function F6 is reduced, the frictional torque of the bearing increases, as shown in FIG. 7. In particular, it can be seen that when the function F6 is 0.5 or less, there is a sharp increase in the bearing frictional torque ratio and bearing performance suffers. One of the causes of this is believed to be that the viscosity of the lubricating fluid rises sharply at low temperature. Therefore the results in FIGS. 5 and 7 tell us that the function F6 (the amount of wear) such that 0.5≦F6≦1.2 is a preferable range for a hydrodynamic bearing, and this range constitutes a novel technological concept that did not exist in the past.

It can also be seen from FIG. 7 that if the wear effect function F7 is less than 2.5×10⁴, the bearing frictional torque ratio increases and bearing performance deteriorates markedly. Therefore, the preferred range for function F7 is 2.5×10⁴≦F7≦7×10⁴, and this range constitutes a novel technological concept that did not exist in the past.

Table 1 below shows examples of the numerical values of functions F6 and F7 for the hydrodynamic bearing device 19 in Embodiment 1. It can be seen that the hydrodynamic bearing devices 19 pertaining to examples A and B of the present invention are both constituted so as to satisfy 0.5≦F6≦1.2 and 2.5×10⁴≦F7≦7×10⁴.

TABLE 1

| Symbol | Category | Unit | Example A | Example B |
|---|---|---|---|---|
| | Trust attraction by Mg | gr | 40 | 45 |
| | Motor rotor weight | gr | 1.5 | 0.9 |
| | | N | 0.015 | 0.009 |
| | Disk part weight (disk, spacer, clamper, | gr | 1.2 | 0.3 |
| | screw, etc.) | | | |
| Pz | Total thrust load (calculated value) | gr | 42.7 | 46.2 |
| | | Pz: N | 0.42 | 0.45 |
| η | Oil absolute viscosity (70° C.): η | CP | 5.4 | 5.4 |
| | | η: N · S/mm² | 0.0054 | 0.0054 |
| Ro | Thrust bearing: pump-in groove outside | θ: mm | 6.20 | 4.90 |
| | diameter | Ro: m | 0.00310 | 0.00245 |
| Ri | Thrust bearing: pump-in groove inside | θ: mm | 4.50 | 2.20 |
| | diameter | Ri: m | 0.00225 | 0.00110 |
| | Groove depth (constant 5 μm assumed) | m | 0.000005 | 0.000005 |
| S | Tilt of thrust face = (0.0002 mm/per mm | — | 0.0002 | 0.0002 |
| | thrust bearing outside diameter) | tilt S: m | 0.00000124 | 0.00000098 |
| F2 | Equivalent speed at start of float exceeding | function: F2 | 179 | 233 |
| | amount of tilt | | | |
| C | Correction coefficient C = 0.10 | | 0.1 | 0.1 |
| F3 | F3 = F2 × motor rotor weight (N) | function: F3 | 2.63 | 2.06 |
| F4 | F4 = F2 × thrust load (N) | function: F4 | 74.8 | 105.6 |
| F5 | F5 = F2/thrust bearing surface area = | function: F5 | 1.251E+07 | 1.549E+07 |
| | F2/(PAI × square of thrust bearing | | | |
| | outside radius − square of inside radius) | | | |
| F6 | F6 = F2 × Ro | wear amount | 0.55 | 0.57 |
| | | function F6 | | |
| F7 | F7 = F2 × Ro/thrust bearing surface area | wear effect | 3.878E+04 | 3.794E+04 |
| | | function F7 | | |

The symbols used in Table 1 conform to the above-mentioned mathematical formulas and FIGS. 2 and 3. Additionally, the “disk part weight” in Table 1 includes not only the disk weight but also the weight of a clamper, a spacer, a screw and the like for fixing the disk to the “motor rotor”. The “motor rotor” in Table 1 indicates the rotating part of a motor excluding the “disk part”.

Thus, with the hydrodynamic bearing device 19 pertaining to this embodiment, we define new functions, namely, the function F6 (wear amount function) and function F7 (wear effect function), and keep these numerical values within specific ranges that are different from those in the past, which allows the required bearing performance to be satisfied and provides a thrust bearing face with a longer intermittent service life.

Hereinafter, these functions F6 and F7 will be referred to collectively as the thrust bearing service life equivalent functions.

Deriving the Capillary Pressure Function

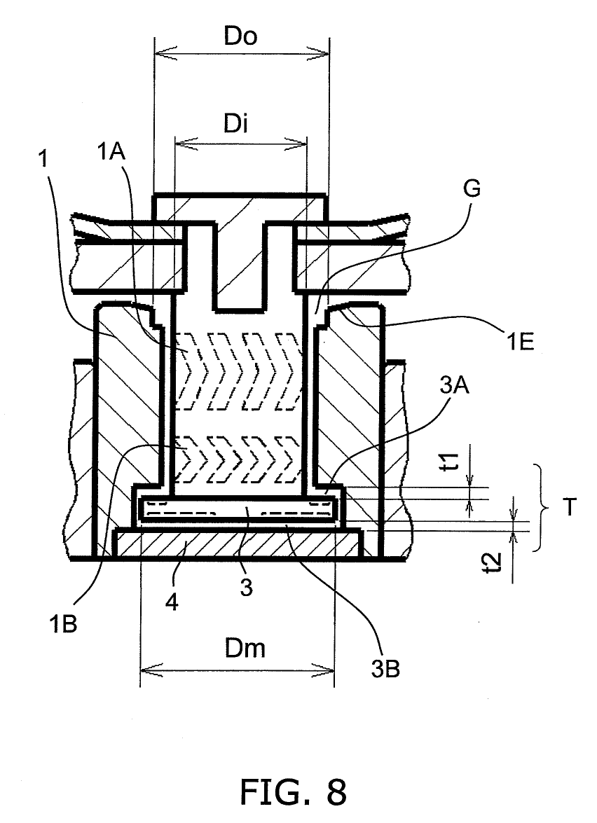

Next, the derivation of the capillary pressure function will be described through reference to FIGS. 8, 9, 10, 11, and 12.

To apply functions F6 and F7 (the thrust bearing service life equivalent functions), it is a prerequisite that the gap at the thrust bearing face be completely filled with lubricating fluid.

However, with the hydrodynamic bearing device 19 in FIG. 8, if bubbles should find their way into the bearing gap including the thrust hydrodynamic grooves 3A and 3B and cause lubricating fluid film separation (oil film breakdown), the functions F6 and F7 may not be satisfied. If lubricating fluid film separation (oil film breakdown) occurs, in most cases there will be considerable wear and the intermittent service life of the thrust bearing face will be shortened.

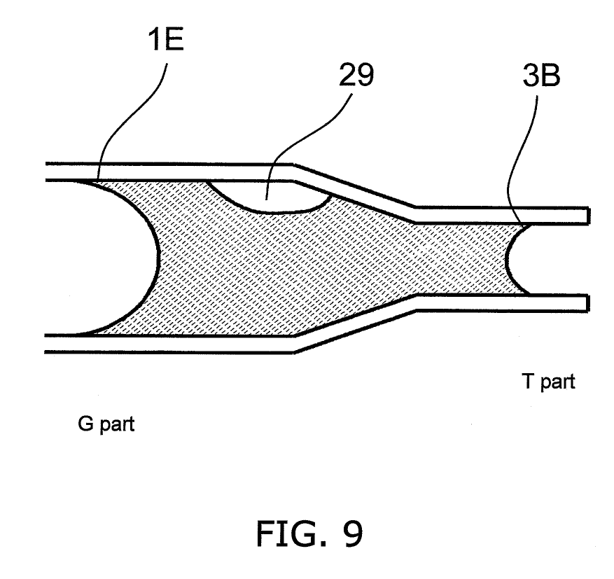

FIG. 9 is a schematic diagram of the maximum gap T between thrust bearing faces in FIG. 8 (corresponds to the amount of looseness in the thrust direction, and is expressed by T=t1+t2) and the maximum gap G at the opening of the lubricating fluid reservoir. This diagram illustrates the capillary pressure at parts T and G.

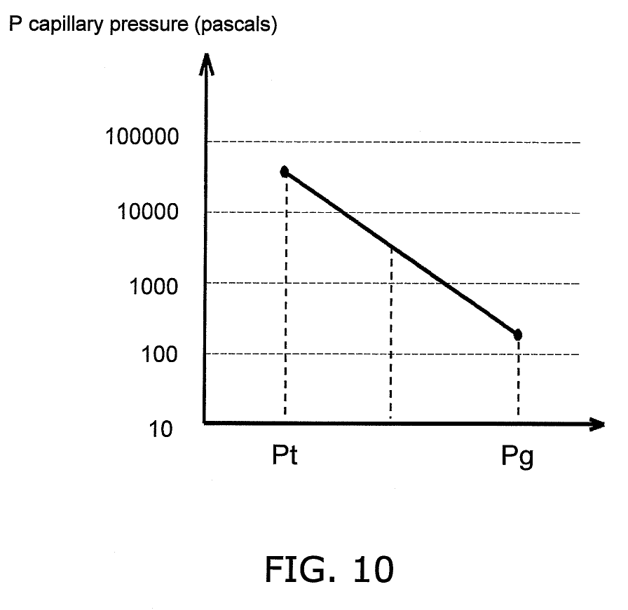

As shown in FIG. 10, we will let Pt be the capillary pressure function at the maximum gap T of the thrust bearing face, and Pt be the capillary pressure function at the maximum gap G of the opening in the lubricating fluid reservoir 1E. The hydrodynamic bearing device 19 is configured so that the relationship Pt>Pg is satisfied. Consequently, capillary pressure causes the lubricating fluid to flow toward the maximum gap T, and the reaction to this discharges a bubble 29A toward the maximum gap G at the open end of the bearing. As a result, the lubricating fluid is less susceptible to film separation in the thrust hydrodynamic grooves 3A and 3B, and better lubrication can be carried out. This means that the relationship between the numerical values of the functions F6 and F7 discussed above and the intermittent service life of the thrust bearing face has an even better correlation.

Thus, the hydrodynamic bearing device 19 pertaining to this embodiment is constituted so as to satisfy the relationship Pt>Pg, where Pt is the capillary pressure function at the maximum gap T of the thrust bearing face, and Pg is the capillary pressure function at the maximum gap G of the opening in the lubricating fluid reservoir 1E.

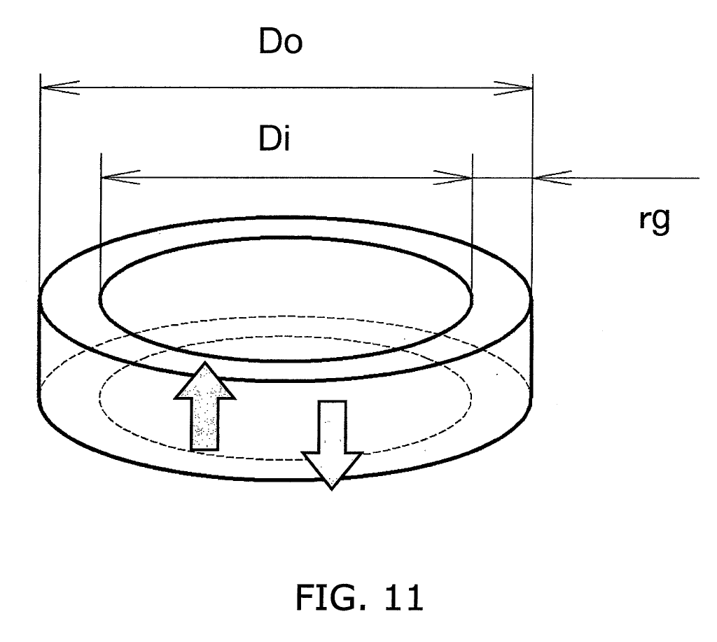

The function Pg here is expressed in the following <3>, since the G portion of the gap shape in FIG. 8 (the shape of the opening in the lubricating fluid reservoir 1E) is substantially that of a circular tube, as shown schematically in FIG. 11.

<3>

Fgo=π×Do×γ×cos θ (8)

Fgi=π×Di×γ×cos θ (9)

Di=Do−2×rg (10)

Fg=Fgo+Fgi (11)

Ag=π×(Do²−Di²)/4 (12)

Pg=Fg/Ag (13)
γ: surface tension of lubricating fluid (N/m)
θ: contact angle of lubricating fluid (rad)
Do: outside diameter of circular tube (m)
Di: inside diameter of circular tube (m)
rg: lubricating fluid film thickness on circular tube (m)

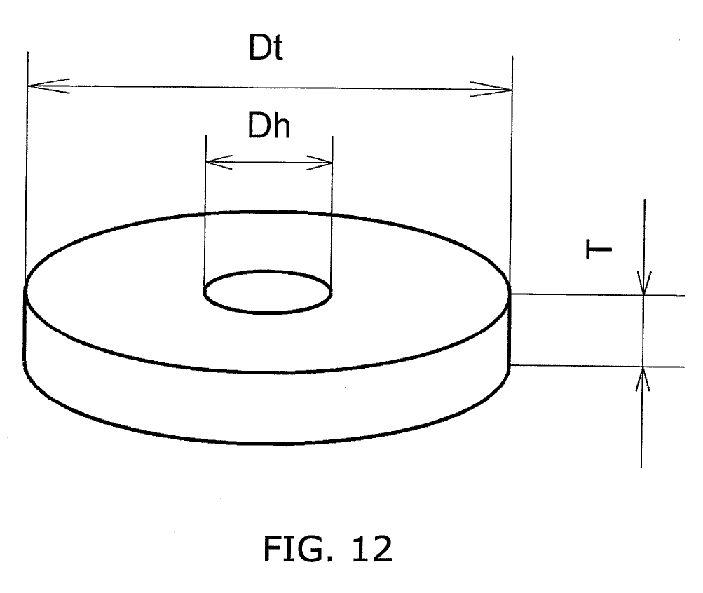

The function Pt is expressed in the following <4>, since the T portion of the gap shape in FIG. 8 (the shape of the thrust bearing face) is substantially that of a thin disk, as shown schematically in FIG. 12.

<4>

Ft=2π×Dt×γ×cos θ (14)

At=π×Dt×T (15)

Pt=Ft/At (16)
Dt: outside diameter of thrust bearing face having the maximum gap T (m)
T: film thickness of lubricating fluid on thrust bearing portion (m)

T=t1+t2 (m) (17)
t1: a gap in the upward direction of the thrust bearing
t2: a gap in the downward direction of the thrust bearing

In FIGS. 1 and 8, the dimension Dh shown in FIG. 12 is zero.

Thus, by satisfying the condition that Pt>Pg, a force is obtained that tries to move the lubricating fluid 5 by capillary pressure differential from the opening in the lubricating fluid reservoir 1E to the thrust bearing face, and the gap between the thrust bearing faces can be completely filled with the lubricating fluid 5.

It can also be seen that by specifying the functions related to capillary pressure and imparting a specific relationship thereto, oil film separation is eliminated in the gap between the thrust bearing faces, which maximizes the synergistic effect of these.

A more favorable hydrodynamic bearing device can be provided by constituting a hydrodynamic bearing device that satisfies both the capillary pressure functions and the thrust bearing service life equivalent functions as discussed above.

Tables 2 and 3 below show examples of this embodiment. In both, the relationship Pt>Pg is satisfied, where Pt and Pg are capillary pressure functions for the maximum gap T of the thrust bearing face and the maximum gap G of the opening in the lubricating fluid reservoir 1E.

The specific numerical values of Pt and Pg in these examples are given below.

TABLE 2

| Category | Symbol | Unit | Example C |
|---|---|---|---|
| Oil surface tension | γ | N/m | 0.028800 |
| Oil contact angle (contact angle on polished glass) | θ | rad | 0.226900 |

Mathematical Formula C (open end of lubricating fluid reservoir: circular tube shaped)

| | | | |
|---|---|---|---|
| Outside diameter of circular tube | Do | m | 0.006000 |
| Oil film thickness of circular tube | rg | m | 0.00002000 |
| Inside diameter of circular tube | Di | m | 0.005960 |
| Function | Fgo | | 0.000528953 |
| Function | Fgi | | 0.000525426 |
| Function | Fg | | 0.001054379 |
| Function | Ag | | 3.75734E−07 |
| Capillary pressure function | Pg2 | | 2806.2 |

Mathematical Formula D (thrust bearing gap: thin disk shaped)

| | | | |
|---|---|---|---|
| Thrust bearing face outside diameter | Dt | m | 0.004800 |
| Thrust bearing maximum oil film thickness | T = t1 + t2 | m | 0.00001000 |
| Function | Ft | | 0.000846324 |
| Function | At | | 1.50796E−07 |
| Capillary pressure function | Pt | | 5612.4 |
| | | PI = | 3.141593 |
| | | cos(θ) = | 0.974368 |

TABLE 3

| Category | Symbol | Unit | Example D |
|---|---|---|---|
| Oil surface tension | γ | N/m | 0.028800 |
| Oil contact angle (contact angle on polished glass) | θ | Rad | 0.226900 |

Mathematical Formula C (open end of lubricating fluid reservoir: circular tube shaped)

| | | | |
|---|---|---|---|
| Outside diameter of circular tube | Do | m | 0.005500 |
| Oil film thickness of circular tube | rg | m | 0.00003500 |
| Inside diameter of circular tube | Di | m | 0.005430 |
| Function | Fgo | | 0.000484873 |
| Function | Fgi | | 0.000478702 |
| Function | Fg | | 0.00963575 |
| Function | Ag | | 6.00908E−07 |
| Capillary pressure function | Pg2 | | 1603.5 |

Mathematical Formula D (thrust bearing gap: thin disk shaped)

| | | | |
|---|---|---|---|
| Thrust bearing face outside diameter | Dt | m | 0.004000 |
| Thrust bearing maximum oil film thickness | T = t1 + t2 | m | 0.00002000 |
| Function | Ft | | 0.00070527 |
| Function | At | | 2.51327E−07 |
| Capillary pressure function | Pt | | 2806.2 |
| | | PI = | 3.141593 |
| | | cos(θ) = | 0.974368 |

It can be seen from the above that with the hydrodynamic bearing device 19 pertaining to this embodiment, no abnormal wear occurs at the thrust bearing face even under high-temperature usage conditions (a harsh environment regarding the intermittent service life of the thrust bearing face). Thus, higher reliability can be ensured, as required in automotive devices and in consumer devices such as disk rotation devices.

The rg shown in the Formula 10 above is the gap shape of the opening of the lubricating fluid reservoir 1E. That is, rg indicates the lubricating fluid thickness at the vapor-liquid boundary located near the open end of the sleeve 1.

The opening of the hydrodynamic bearing device 19 shown in FIG. 8 is such that the peripheral surface of the sleeve member or the shaft 2 (hereinafter referred to as the bearing seal face) is tilted in the direction in which the gap widens toward the open end side of the sleeve 1 (corresponds to the inside diameter part indicated by the dimension Do in FIG. 8, but the tilt cannot be perceived in the drawing) so that the lubricating fluid 5 will not leak out. Further, the vapor-liquid boundary located near the open end of the sleeve 1 may not be formed substantially vertical to the axial direction, and may instead be formed tilted. Therefore, when the inner and outer bearing seal faces have an angle α with respect to one another, the bisector of the inner and outer bearing seal faces may also be tilted (α/2). In this case, if Formula 8 is expressed strictly, for example, we obtain the following Formula 8b.

Fgo=π×Do×γ×cos θ×cos(α/2) (8b)

The angle α of the above-mentioned bearing seal faces is about 20 degrees at most, and the resulting tilt of the vapor-liquid boundary is about 10 degrees. Since cos(α/2) here is approximately equal to 0.985, the effect of the angle α of the bearing seal faces in Formula 2 is considered small enough that it can be ignored.

As a specific example, the diameter of the shaft 2 of the hydrodynamic bearing device 19 is between 2.0 and 6.0 mm, and the rotational speed is between 360 and 15,000 rpm. The inner peripheral surface of the sleeve 1 is a bearing hole, usually there are radial bearing faces at two places, and the length of the bearing hole is between 3.0 and 20 mm.

When the shaft 2 or the sleeve 1 rotates, the rotating side is subjected to rotational load, and the load to which the thrust bearing is subjected is 300 grams (approximately 2.94 Newtons) or less.

The reason for this is to enhance the overall performance, including the wear resistance, rotational frictional torque, and so forth, and to obtain a stable amount of float of the thrust hydrodynamic bearing, which is the object of the present invention.

The diameter of the hydrodynamic bearing, the bearing hole length, and the rotational speed are preferably such that the diameter is 2 to 6 mm, the hole length is 3 to 20 mm, and the rotational speed is 360 to 15,000 rpm. Below these numerical values, no enough float will be obtained within the practical design range, but if these numerical values are exceeded, the rotational frictional torque will be too high and the overall performance of the hydrodynamic bearing may suffer.

If the thrust load is 300 grams or less, it will be possible to reduce the rotational frictional torque while obtaining a stable amount of float at the same time, but if the thrust bearing is subjected to a large load that exceeds this, contact scratches will be made on the bearing face and reliability may suffer.

With the hydrodynamic bearing device 19 pertaining to this embodiment, out of these many design parameters, applying new design values to the thrust bearing face that will make wear less likely to occur has a synergistic effect. This was invented on the basis of experimental facts.

Effect of Embodiment 1

With this embodiment, new functions (functions F6 and F7) are defined, and their numerical values are designed within specific ranges that are different from those in the past, which makes it possible to provide a novel hydrodynamic bearing device 19 with which an increase in the wear resistance of the thrust bearing face can be achieved efficiently.

Also, the functions related to capillary pressure are specified and kept to constant numerical values, which prevents lubricating fluid separation (oil film separation) in the gap between thrust bearing faces. Therefore, because of the synergistic effect of defining these new functions, an even better hydrodynamic bearing device 19 can be provided.

Also, with a spindle motor 15 equipped with the hydrodynamic bearing device 19 pertaining to this embodiment, and with an information recording and reproducing apparatus equipped with the spindle motor 15, a longer service life can be achieved without leading to a decrease in performance or quality.

### Embodiment 2

Configuration of Spindle Motor 30

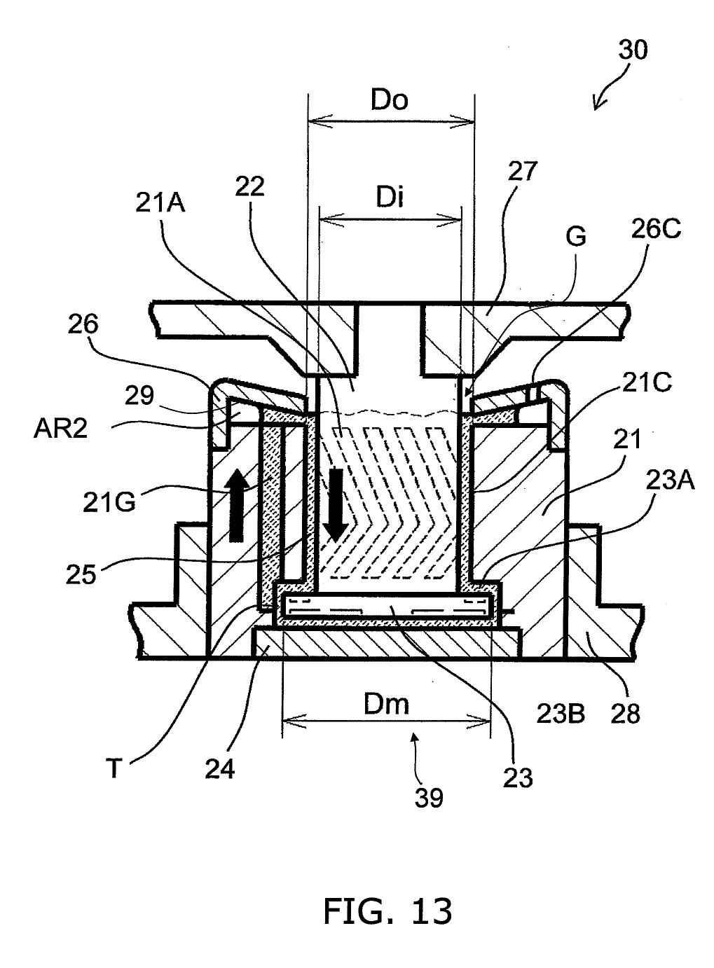

FIG. 13 is a partial cross section of a spindle motor 30 in Embodiment 2 of the present invention.

The spindle motor 30 of this embodiment comprises a hydrodynamic bearing device 39, a base 28, a hub rotor 27, and a stator, rotor magnet, and so forth (not shown).

As shown in FIG. 13, the hydrodynamic bearing device 39 has a sleeve 21, a shaft 22, a flange 23, a thrust plate 24, and oil or another such lubricating fluid 25. The sleeve 21 is fixed to the base 28.

The outer peripheral surface in the circumferential direction of the shaft 22 and/or the inner peripheral surface of a bearing hole 21C of the sleeve 21 is provided with a radial hydrodynamic groove 21A in a herringbone or other such pattern, forming a radial bearing. Meanwhile, thrust hydrodynamic grooves 23A and 23B are provided to the face of the flange 23 that is opposite the sleeve 21 in the axial direction and to the face of the flange 23 that is opposite the thrust plate 24 in the axial direction, forming thrust bearing faces.

The hydrodynamic bearing device 39 differs from the hydrodynamic bearing device 19 pertaining to Embodiment 1 on the following points. A cover 26 fixed to the base 28 or the sleeve 21 is attached to the open side of the sleeve 21, and holds in the lubricating fluid 25. A communicating path 21G is formed in the sleeve 21. The cover 26 is formed so that the axial direction gap becomes smaller from the outer peripheral part formed on the inside, toward the inner peripheral part. The cover 26 also has an exhaust hole 26C. The communicating path 21G has a communicating hole formed in it by drilling, for example.

Operation of the Spindle Motor 30

The operation of the spindle motor 30 that has the above constitution will now be described through reference to FIG. 13, focusing on the differences from Embodiment 1.

With the spindle motor 30 in Embodiment 2, the lubricating fluid 25 receives a circulation force toward the flange 23, in the direction of the downward arrow in the drawing, by the hydrodynamic groove 21A formed asymmetrically in the axial direction. As a result, air AR2 that has generated or accumulated in the interior of the hydrodynamic bearing device 39 also moves. After this, the air AR2 passes through the communicating path 21G, from bottom to top in FIG. 13, and moves to a lubricating fluid reservoir 29 formed by the cover 26 and the sleeve 21. The air AR2 is separated and discharged from the exhaust hole 26C by an vapor-liquid separation structure that generates capillary pressure by an axial direction gap G that is formed in the interior of the cover 26 and becomes smaller from the outer peripheral part toward the inner peripheral part. Accordingly, with the hydrodynamic bearing device 39, since air is constantly being discharged, the lubricating film does not break down in the hydrodynamic grooves 21A, 23A, and 23B. Also, the lubricating fluid 25 that is separated from the air AR2 by the vapor-liquid separation structure circulates back to a radial bearing gap formed by the shaft 22 and the sleeve 21, and circulates through the loop described above.

Application of Thrust Bearing Service Life Equivalent Functions and Capillary Pressure Functions

With the hydrodynamic bearing device 39, the method for applying the functions F6 and F7 (thrust bearing service life equivalent functions) and Pg and Pt (capillary pressure functions) is the same as in Embodiment 1, and will therefore not be described again in detail.

Effect of Embodiment 2

With the hydrodynamic bearing device 39 pertaining to this embodiment, in addition to the effect of Embodiment 1, no abnormal wear occur even under high-temperature usage conditions (a harsh environment regarding the bearing service life). Thus, higher reliability can be ensured, as required in automotive devices and in consumer devices such as disk rotation devices.

### Embodiment 3

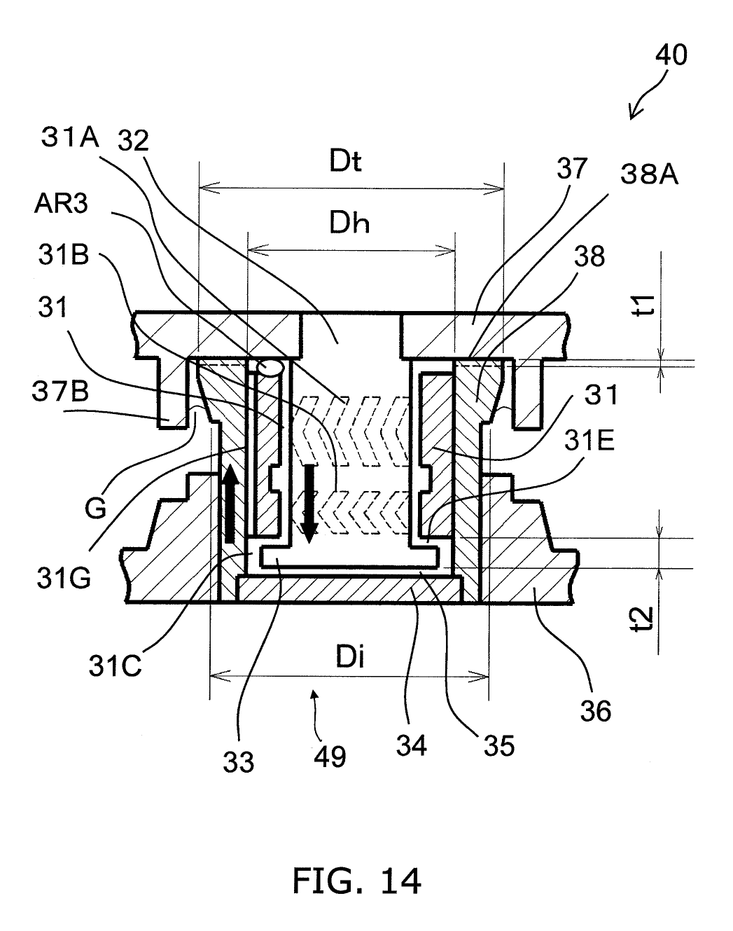

FIG. 14 is a partial cross section of a spindle motor 40 in Embodiment 3 of the present invention.

The spindle motor 40 of this embodiment comprises a hydrodynamic bearing device 49, a base 36, a hub rotor 37, and a stator, rotor magnet, and so forth (not shown).

As shown in FIG. 14, the hydrodynamic bearing device 49 has a sleeve 31, a shaft 32, a flange 33, a thrust plate 34, and oil or another such lubricating fluid 35.

The outer peripheral surface in the circumferential direction of the shaft 32 and/or the inner peripheral surface of a bearing hole 31C of the sleeve 31 is provided with radial hydrodynamic grooves 31A and 31B in a herringbone or other such pattern, forming a radial bearing. Meanwhile, a hydrodynamic groove 31E is provided to either one of the faces of the flange 33 and the sleeve 31 that are opposite in the axial direction.

The hydrodynamic bearing device 49 and the spindle motor 40 in this embodiment differ from the spindle motor 15 pertaining to Embodiment 1 on the following points.

As shown in FIG. 14, the hydrodynamic bearing device 49 has a holder 38 for fixing the sleeve 31, a recess 31C formed by the sleeve 31 and the holder 38 on the flange 33 side, and a communicating path 31G formed by either the holder 38 or the sleeve 31. A hydrodynamic groove 38A is formed on the opening-side end face of the holder 38. The flange 33 is accommodated in the recess 31C. A cylindrical portion 37B formed on the hub rotor 37 is formed on the opening side of the sleeve 31.

On the opening side of the sleeve 31, the lubricating fluid 35 collects in the gap between the sleeve 31 and the cylindrical portion 37B, and the lubricating fluid 35 fills at least the hydrodynamic grooves 31B, 31E, and 38A.

The communicating path 31G may be formed, for example, by machining a groove around the outside of the sleeve 31, and forms a communicating groove in combination with the holder 38.

Operation of the Spindle Motor 40

The differences in the operation of the spindle motor 40 that has the above constitution from that in Embodiment 1 will now be described.

With the spindle motor 40 in this embodiment, air AR3 that has generated or accumulated in the interior of the bearing is dealt with as follows. The lubricating fluid 35 receives a circulation force toward the flange 33, in the direction of the downward arrow in the drawing, by the hydrodynamic grooves 31A and 31B formed asymmetrically in the axial direction. As a result, the air AR3 that has generated or accumulated in the interior of the bearing also moves. After this, the air AR3 passes through the communicating path 31G, from bottom to top in the drawing, and moves to a lubricating fluid reservoir formed by the hub rotor 37 and the sleeve 21. The air AR3 that has moved here passes through the thrust hydrodynamic groove 38A and is discharged to the outside at a point when there is a large movement of lubricating fluid, such as at start-up. Since air in the bearing gap moves and is discharged, this prevents breakdown of the lubricating film in the hydrodynamic grooves 31A, 31B, 38A, and 31E. The lubricating fluid 35 that is separated from the air AR3 circulates back to a radial bearing gap formed by the shaft 32 and the sleeve 31, and circulates through the loop described above.

Application of Thrust Bearing Service Life Equivalent Functions and Capillary Pressure Functions

With the hydrodynamic bearing device 49 of the spindle motor 40, the method for applying the functions F6 and F7 (thrust bearing service life equivalent functions) and Pg and Pt (capillary pressure functions) is similar to that in Embodiment 1, and only the differences from Embodiment 1 will be discussed below.

As shown in FIG. 14, since the thrust bearing face is in the form of a hollow disk, its outside diameter is denoted by Dt, and its inside diameter by Dh. FIG. 12 shows this in schematic form.

The capillary pressure function Pt here is expressed in the following <5>.

<5>

Ft=2π×Dh×γ×cos θ (18)

At=π×Dh×T (19)

Pt=Ft/At (20)
Dh: inside diameter of thrust bearing face having the maximum gap T (m)
T: film thickness of lubricating fluid on thrust bearing portion (m)

T=t1+t2 (m) (21)
t1: a gap in the upward direction of the thrust bearing
t2: a gap in the downward direction of the thrust bearing

The holder 38 and the sleeve 31 are configured separately in Embodiment 3 shown in FIG. 14 but may be integrally produced instead.

Effect of Embodiment 3

With the spindle motor 40 and hydrodynamic bearing device 49 pertaining to this embodiment, in addition to the effect of Embodiment 1, no abnormal wear occurs even under high-temperature usage conditions (a harsh environment regarding the bearing service life). Thus, higher reliability can be ensured, as required in automotive devices and in consumer devices such as disk rotation devices.

Other Effects

We will now discuss other effects that are common to Embodiments 1 to 3 and to other the embodiments discussed below.

As to the wear amount function F6, the intermittent service life of the thrust hydrodynamic bearing will be good as described above if the value of F6 is 1.2 or less, but subsequent evaluations have revealed that in addition to the effect of improving wear resistance that is an object of the present invention, the other two effects below are obtained at the same time.

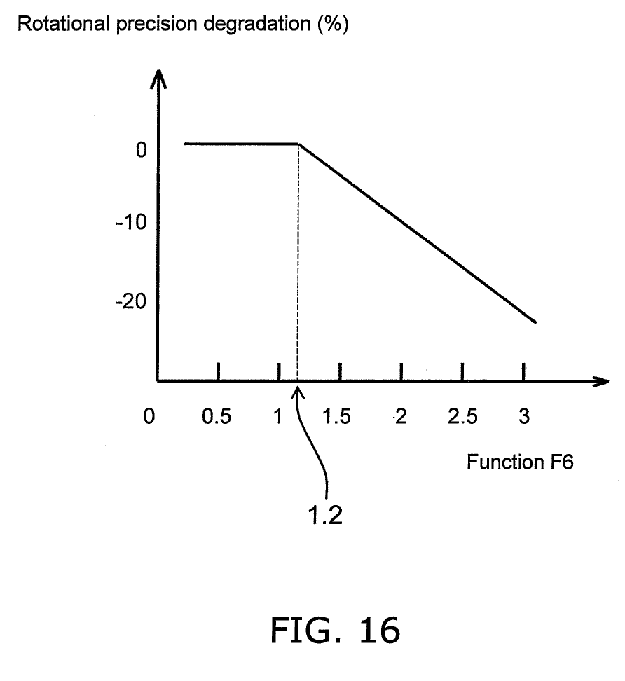

a) In FIG. 16, the vertical axis is the percentage decrease in performance after 1000 hours of operation in terms of the non-repeatable runout (generally abbreviated as NRRO) of a radial hydrodynamic bearing, which is one aspect of the performance of a hydrodynamic bearing rotation device. As shown in FIG. 16, the performance decrease of non-repeatable runout was found to be correlated to the function F6, and it was found that the decrease in performance is smaller if the value of F6 is 1.2 or less.

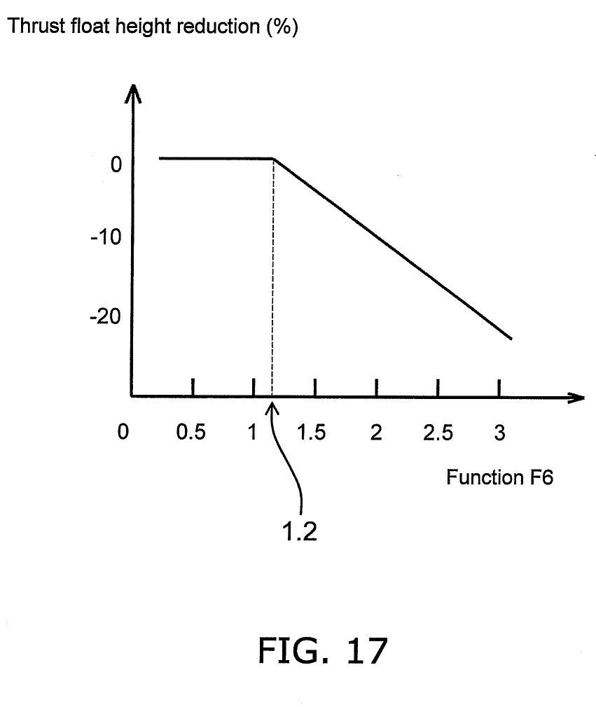

b) In FIG. 17, the vertical axis is the percentage reduction, after 1000 hours of operation, in the float height during rotation of the thrust hydrodynamic bearing face of this hydrodynamic bearing device. Thus, again with the float height of the thrust hydrodynamic bearing, it was confirmed that there will be less reduction and the float height can be kept at an adequate level over an extended period as long as the function F6 is 1.2 or less.

Also, as is clear from FIGS. 16 and 17, the value of the wear amount function F6 not only has the effect of extending the service life of the thrust bearing face, but also prevents heat from being generated during bearing contact, so an additional effect is that less heat is generated and there is less thermal degradation at a radial bearing face adjacent to a thrust bearing face. Therefore, it is possible to maintain the performance of both the radial bearing face and the thrust bearing face over an extended period.

Other

The following points are all common to Embodiments 1 to 3 given above.

Materials

First, in Embodiments 1 to 3 shown in FIGS. 8, 13, and 14, stainless steel, high-manganese chromium steel, or carbon steel is used for the shafts 2, 22, and 32.

Also, stainless steel, a copper alloy, or one of these whose surface has been subjected to electroless nickel plating or DLC coating is used for the material of the sleeves 1, 21, and 31. Also, the material of the sleeves 1, 21, and 31 may be a sintered alloy containing at least 90% iron, or a material obtained by forming a triiron tetroxide film or a diiron trioxide film on the surface of a sintered alloy containing at least 90% iron, by which a certain amount of wear resistance is obtained.

When a copper alloy that has not been plated is used for the bearing material of the sleeves 1, 21, and 31 or the shafts 2, 22, and 32, the oil may chemically react with the copper component and accelerate degradation, which could shorten the service life of the hydrodynamic bearing device by about 10%. These factors are not taken into account, however, with the thrust bearing service life equivalent functions F6 and F7 defined in the present invention.

Surface Roughness

Furthermore, the radial bearing face is machined so that its surface roughness falls within a range of 0.01 to 1.60 μm. As to the surface roughness of the shafts 2, 22, and 32, the specified wear resistance is obtained by machining to within a range of 0.01 to 0.2 μm. The surface roughness here generally may be measured by using a surface roughness gauge with a method called the ten-point average roughness or the arithmetic mean roughness (with the cutoff value set to 0.25 mm), but the arithmetic mean roughness is used in these embodiments.

This is because a stable amount of float of the thrust hydrodynamic bearing is obtained, and a bearing with an excellent balance of wear resistance is obtained, which are part of the object of the present invention.

The surface roughness of the radial bearing face is favorably 0.01 to 1.6 μm, and if it is less than 0.01 μm, good wear resistance may not be obtained because the lubricating fluid is less likely to form an oil film on the bearing surface. If the surface roughness of the radial bearing face is over 1.6 μm, under conditions of little thrust float, it may be difficult to generate hydrodynamic pressure between the bearing surfaces, and any pressure that is generated may end up leaking through the surface roughness, so the specified float force (load capability) cannot be generated.

Viscosity of Lubricating Fluid

Next, we will describe how to find the viscosity of lubricating fluids 5, 25, and 35 such as oil.

First, if the lubricating fluid is an oil, a small amount of the lubricating fluid is put in an analyzer called a gas chromatography (not shown) to examine the oil composition, and the type of oil is specified from the resulting composition. The oil type thus found can be used to determine the viscosity of the oil at 40° C. and 100° C. on the basis of known data. This known data is, for example, the data given on pages 311-313 of Principle of Application to Lubricating Oil (written by Seiichi Konishi, published by Corona). For instance, if the analyzer reveals that the type of oil is a dibasic acid ester, then the viscosity of this oil at 40° C. is 7.4 to 10.4 Cst (centistokes), and at 100° C. is 1.9 to 2.3 Cst. It can therefore be seen that the viscosity at 70° C. is approximately 3.9 Cst.

Common values for the specific gravity of the lubricating fluids 5, 25, and 35 are approximately 0.9 for an ester oil, approximately 1.4 for a silicone oil, approximately 1.8 for a fluorine oil, and approximately 0.9 for a dibasic acid ester. Thus, the absolute viscosity of an oil at 70° C. is 3.9 (Cst)×0.9=3.51 (CP; centipoise), and converting the units gives us absolute viscosity=0.00351 N·S/m².

Experiments have shown that regardless of the viscosity of the lubricating fluid, it is possible to obtain a hydrodynamic bearing device having values for the thrust bearing service life equivalent functions (F6 and F7) that are favorable for a hydrodynamic bearing, by employing the formulas discussed above. However, if the viscosity of the lubricating fluid at 70° C. is too high, there may be situations in which the rotational torque at low temperature is so high that good performance cannot be obtained. In view of this, the preferred range for viscosity was found to be between 2 and 5 CP.

The reason for this is to enhance the overall performance, including the wear resistance, rotational frictional torque, and so forth, and to obtain a stable amount of float of the thrust hydrodynamic bearing, which is the object of the present invention.

It is good for the lubricating fluid viscosity to be from 2 to 5 CP. If it is less than 2 CP, sufficient float will not be obtained within the practical design range, and if it is over 5 CP, the rotational frictional torque will be too high and the overall performance of the hydrodynamic bearing may suffer.

### Other Embodiments

Embodiments of the present invention were described above, but the present invention is not limited to the above embodiments, and various modifications are possible unless departing from the gist of the invention. Other embodiments will be described in (A), (B), and (C) below.

(A)

In the above embodiments, an example is described in which the lubricating fluid 5, 25, or 35, which is, for example, an oil that is a non-compressible fluid, is injected into the gap between the shaft 2, 22, or 32 and the sleeve 1, 21, or 31. The present invention is not limited to this, however.

For instance, substantially the same effect is obtained when using a gas bearing in which air or another such compressed gas is injected into this gap. In this case, if the lubricating fluid viscosity η is I=0.00001 (called a gas viscosity equivalent constant) so that the absolute viscosity of the gas is treated as if it were a non-compressible fluid, then as shown in FIG. 6, the measured value of intermittent service life will match up, and the intermittent service life of the hydrodynamic bearing device can be predicted.

(B)

In the above embodiments, an example of the bearing structure is given in which the shaft 2, 22, or 32 rotates, and the sleeve 1 is sealed in the form of a pocket, but the present invention is not limited to this.

For example, as shown in FIG. 1 of U.S. Pat. No. 5,112,142 (Hydrodynamic Bearing), it is also possible to apply the present invention to a hydrodynamic bearing device in which both ends of the shaft are fixed and the sleeve is able to rotate.

(C)

A spindle motor equipped with the hydrodynamic bearing device of the present invention can also be utilized as follows, for example.

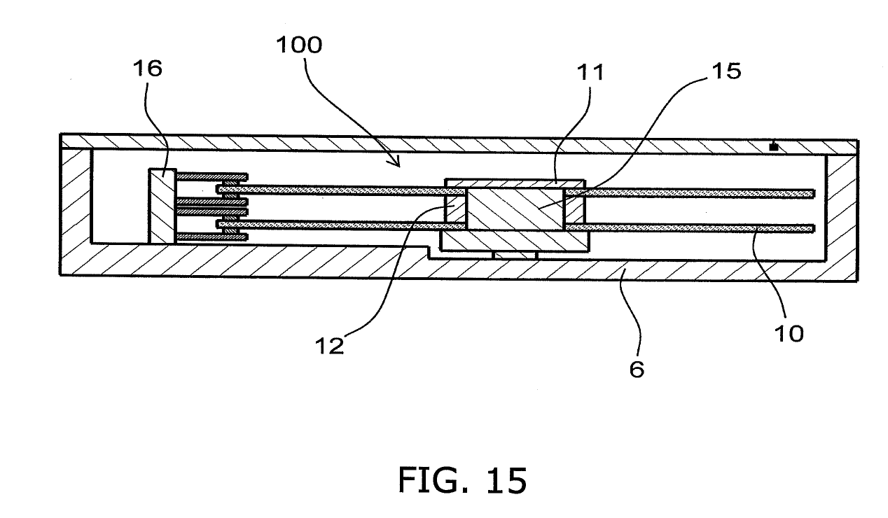

As shown in FIG. 15, the spindle motor 15, 30, or 40 having the above constitution can be mounted in an information recording and reproducing apparatus 100. The information recording and reproducing apparatus 100 is used to reproduce information recorded to a recording disk 10 by a recording head 16, or to record information to the recording disk 10.

When the spindle motor 15 equipped with the hydrodynamic bearing device of the present invention is applied to the information recording and reproducing apparatus 100, high-density recording can be accomplished with little axial runout of the disk 10, or radial runout.

Also, with the information recording and reproducing apparatus 100, temperature elevation within the apparatus 100 is kept low, so that almost no temperature change is imparted to the recording and reproducing performed between the magnetic disk 10 and the recording head 16. Also, since there is very little temperature elevation within the apparatus 100, there is no risk that the lubricating fluid 5, 25, or 35 used in the hydrodynamic bearing device 19, 39, or 49 will be exposed to a high temperature and evaporate off, so a high-quality recording and reproducing apparatus 100 is obtained.

Also, because they have the features discussed above, the hydrodynamic bearing device and spindle motor of the present invention are useful in automotive devices and in consumer devices such as disk rotation devices.

With the present invention, high reliability can be ensured because no abnormal wear occurs even under high-temperature usage conditions, which is a harsh environment when it comes to bearing life. Therefore, the present invention can be utilized as a hydrodynamic bearing device, spindle motor, and information recording and reproducing apparatus that can be used in special applications that could be called semi-permanent, in which the amount of wear is substantially zero.

What is claimed is:

1. A hydrodynamic bearing device, comprising:
a sleeve having a bearing hole;
a shaft that is inserted into the bearing hole in a state of being capable of rotating relative to the sleeve;
a thrust bearing portion having a hydrodynamic groove that generates pressure in an axial direction; and
a lubricating fluid adapted to be held in a gap formed by at least the thrust bearing portion,
the device being configured such that a value of a function F6 expressed by Formula 1 as follows is within a specific range.
F6=F2×Ro (1)
F2=S²×Pz/(C²×η×(Ro⁴−Ri⁴)) (2)
S: thrust bearing face tilt amount
S=θ×2×Ro (3)
θ: thrust bearing face tilt angle
θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

2. The hydrodynamic bearing device according to claim 1,
being configured such that the value of the function F6 satisfies the following.
F6<1.2

3. The hydrodynamic bearing device according to claim 1,
being configured such that the value of the function F6 satisfies the following.
F6>0.5

4. A hydrodynamic bearing device, comprising:
a sleeve having a bearing hole;
a shaft that is inserted into the bearing hole in a state of being capable of rotating relative to the sleeve;
a thrust bearing portion having a hydrodynamic groove that generates pressure in an axial direction; and
a lubricating fluid adapted to be held in a gap formed by at least the thrust bearing portion,
the device being configured such that the value of a function F7 expressed by Formula 4 as follows is within a specific range.
F7=F2×Ro/At (4)
F2=S²×Pz/(C²×η×(Ro⁴−Ri⁴)) (5)
At=π×(Ro²−Ri²) (6)
S: thrust bearing face tilt amount
S=θ×2×Ro (7)
θ: thrust bearing face tilt angle
θ(rad)=(0.0002 (mm)/thrust bearing outside diameter (mm))
Pz: total thrust load (N)
C: correction coefficient=0.10
η: lubricating fluid viscosity (N·S/mm²)
Ro: thrust hydrodynamic groove outer peripheral radius (m)
Ri: thrust hydrodynamic groove inner peripheral radius (m)

5. The hydrodynamic bearing device according to claim 4,
being configured such that the value of the function F7 satisfies the following.
F7<7×10⁴

6. The hydrodynamic bearing device according to claim 4,
being configured such that the value of the function F7 satisfies the following.
F7>2.5×10⁴

7. The hydrodynamic bearing device according to claim 1,
further comprising a lubricating fluid reservoir that has an opening in the axial direction and adapted to hold a lubricating fluid that is moved by the pressure from the thrust bearing portion,
the device being configured such that the relationship
Pt>Pg
is satisfied, where Pt is a capillary pressure function in a maximum gap T of the thrust bearing portion, and Pg is a capillary pressure function in a maximum gap G of the opening in the lubricating fluid reservoir,
wherein the function Pg is expressed by Formula 13 as follows when a gap shape of the opening in the lubricating fluid reservoir is substantially that of a circular tube,
Fgo=π×Do×γ×cos θ (8)
Fgi=π×Di×γ×cos θ (9)
Di=Do−2×rg (10)
Fg=Fgo+Fgi (11)
Ag=π×(Do²−Di²)/4 (12)
Pg=Fg/Ag (13)
γ: surface tension of lubricating fluid (N/m)
θ: contact angle of lubricating fluid (rad)
Do: outside diameter of circular tube (m)
Di: inside diameter of circular tube (m)
rg: lubricating fluid film thickness on circular tube (m)
and the function Pt is expressed by Formula 16 as follows when a gap shape of the thrust bearing portion is substantially that of a thin disk.
Ft=2π×Dt×γ×cos θ (14)
At=π×Dt×T (15)
Pt=Ft/At (16)
Dt: outside diameter of thrust bearing face having the maximum gap T (m)
T: film thickness of lubricating fluid on thrust bearing portion (m)
T=t1+t2 (m) (17)
t1: a gap in the upward direction of the thrust bearing
t2: a gap in the downward direction of the thrust bearing

8. The hydrodynamic bearing device according to claim 1,
further comprising a lubricating fluid reservoir that has an opening in the axial direction and adapted to hold a lubricating fluid that is moved by the pressure from the thrust bearing portion,
the device being configured such that the relationship
Pt>Pg
is satisfied, where Pt is a capillary pressure function in a maximum gap T of the thrust bearing portion, and Pg is a capillary pressure function in a maximum gap G of the opening in the lubricating fluid reservoir,
wherein the function Pg is expressed by Formula 13 as follows when a gap shape of the opening in the lubricating fluid reservoir is substantially that of a circular tube,
Fgo=π×Do×γ×cos θ (8)
Fgi=π×Di×γ×cos θ (9)
Di=Do−2×rg (10)
Fg=Fgo+Fgi (11)
Ag=π×(Do²−Di²)/4 (12)
Pg=Fg/Ag (13)
γ: surface tension of lubricating fluid (N/m)
θ: contact angle of lubricating fluid (rad)
Do: outside diameter of circular tube (m)
Di: inside diameter of circular tube (m)
rg: lubricating fluid film thickness on circular tube (m)
and the function Pt is expressed by Formula 20 as follows when a gap shape of the thrust bearing portion is substantially that of a hollow disk.
Ft=2π×Dh×γ×cos θ (18)
At=π×Dh×T (19)
Pt=Ft/At (20)
Dh: inside diameter of thrust bearing face having the maximum gap T (m)
T: film thickness of lubricating fluid on thrust bearing portion (m)
T=t1+t2 (m) (21)
t1: a gap in the upward direction of the thrust bearing
t2: a gap in the downward direction of the thrust bearing

9. The hydrodynamic bearing device according to claim 1,
wherein the shaft is composed of stainless steel, high-manganese chromium steel, or carbon steel,
the sleeve is composed of stainless steel or a copper alloy, and
the surface of the sleeve has been subjected to electroless nickel plating or DLC coating.

10. The hydrodynamic bearing device according to claim 1,
wherein the shaft is composed of stainless steel, high-manganese chromium steel, or carbon steel,
the sleeve is a sintered alloy containing at least 90% iron, and
a triiron tetroxide film, a diiron trioxide film, or other such hard oxide film is formed on the surface of the sleeve.

11. The hydrodynamic bearing device according to claim 1,
wherein the absolute viscosity of the lubricating fluid at 70° C. is between 2 and 5 centipoise (0.002 to 0.005 [N·S/m²]).

12. The hydrodynamic bearing device according to claim 1,
wherein a surface roughness of the thrust bearing portion is between 0.01 and 1.6 μm.

13. A spindle motor, comprising the hydrodynamic bearing device according to claim 1.

14. An information recording and reproducing apparatus, comprising the hydrodynamic bearing device according to claim 1.

15. The hydrodynamic bearing device according to claim 4,
further comprising a lubricating fluid reservoir that has an opening in the axial direction and adapted to hold a lubricating fluid that is moved by the pressure from the thrust bearing portion,
the device being configured such that the relationship
Pt>Pg
is satisfied, where Pt is a capillary pressure function in a maximum gap T of the thrust bearing portion, and Pg is a capillary pressure function in a maximum gap G of the opening in the lubricating fluid reservoir,
wherein the function Pg is expressed by Formula 13 as follows when a gap shape of the opening in the lubricating fluid reservoir is substantially that of a circular tube,
Fgo=π×Do×γ×cos θ (8)
Fgi=π×Di×γ×cos θ (9)
Di=Do−2×rg (10)
Fg=Fgo+Fgi (11)
Ag=π×(Do²−Di²)/4 (12)
Pg=Fg/Ag (13)
γ: surface tension of lubricating fluid (N/m)
θ: contact angle of lubricating fluid (rad)
Do: outside diameter of circular tube (m)
Di: inside diameter of circular tube (m)
rg: lubricating fluid film thickness on circular tube (m)
and the function Pt is expressed by Formula 16 as follows when a gap shape of the thrust bearing portion is substantially that of a thin disk.
Ft=2π×Dt×γ×cos θ (14)
At=π×Dt×T (15)
Pt=Ft/At (16)
Dt: outside diameter of thrust bearing face having the maximum gap T (m)
T: film thickness of lubricating fluid on thrust bearing portion (m)
T=t1+t2 (m) (17)
t1: a gap in the upward direction of the thrust bearing
t2: a gap in the downward direction of the thrust bearing

16. The hydrodynamic bearing device according to claim 4,
further comprising a lubricating fluid reservoir that has an opening in the axial direction and adapted to hold a lubricating fluid that is moved by the pressure from the thrust bearing portion,
the device being configured such that the relationship
Pt>Pg
is satisfied, where Pt is a capillary pressure function in a maximum gap T of the thrust bearing portion, and Pg is a capillary pressure function in a maximum gap G of the opening in the lubricating fluid reservoir,
wherein the function Pg is expressed by Formula 13 as follows when a gap shape of the opening in the lubricating fluid reservoir is substantially that of a circular tube,
Fgo=π×Do×γ×cos θ (8)
Fgi=π×Di×γ×cos θ (9)
Di=Do−2×rg (10)
Fg=Fgo+Fgi (11)
Ag=π×(Do²−Di²)/4 (12)
Pg=Fg/Ag (13)
γ: surface tension of lubricating fluid (N/m)
θ: contact angle of lubricating fluid (rad)
Do: outside diameter of circular tube (m)
Di: inside diameter of circular tube (m)
rg: lubricating fluid film thickness on circular tube (m)
and the function Pt is expressed by Formula 20 as follows when a gap shape of the thrust bearing portion is substantially that of a hollow disk.
Ft=2π×Dh×γ×cos θ (18)
At=π×Dh×T (19)
Pt=Ft/At (20)
Dh: inside diameter of thrust bearing face having the maximum gap T (m)
T: film thickness of lubricating fluid on thrust bearing portion (m)
T=t1+t2 (m) (21)
t1: a gap in the upward direction of the thrust bearing
t2: a gap in the downward direction of the thrust bearing

17. The hydrodynamic bearing device according to claim 4,
wherein the shaft is composed of stainless steel, high-manganese chromium steel, or carbon steel,
the sleeve is composed of stainless steel or a copper alloy, and
the surface of the sleeve has been subjected to electroless nickel plating or DLC coating.

18. The hydrodynamic bearing device according to claim 4,
wherein the shaft is composed of stainless steel, high-manganese chromium steel, or carbon steel,
the sleeve is a sintered alloy containing at least 90% iron, and
a triiron tetroxide film, a diiron trioxide film, or other such hard oxide film is formed on the surface of the sleeve.

19. The hydrodynamic bearing device according to claim 4,
wherein the absolute viscosity of the lubricating fluid at 70° C. is between 2 and 5 centipoise (0.002 to 0.005 [N·S/m²]).

20. The hydrodynamic bearing device according to claim 4,
wherein a surface roughness of the thrust bearing portion is between 0.01 and 1.6 μm.

21. A spindle motor, comprising the hydrodynamic bearing device according to claim 4.

22. An information recording and reproducing apparatus, comprising the hydrodynamic bearing device according to claim 4.
